(19) United States
(12) Patent Application Publication
(10) Pub. No.: US 2026/0098785 A1
(43) Pub. Date: Apr. 9, 2026

(54) GALVANOMETRIC SYSTEMS FOR METROLOGY OF BIOCULAR DEVICES

(71) Applicant: Novanta Corporation, Bedford, MA (US)

(72) Inventor: Matt Falanga, Liverpool, NY (US)

(73) Assignee: Novanta Corporation, Bedford, MA (US)

(21) Appl. No.: 19/351,918

(22) Filed: Oct. 7, 2025

Related U.S. Application Data
(60) Provisional application No. 63/704,260, filed on Oct. 7, 2024.

(51) Int. Cl. G01M 11/02

(52) U.S. Cl. CPC G01M 11/0207; G01M 11/0257

(57) ABSTRACT

A galvanometric metrology system for near eye display metrology that uses two parallel channels that can be selectively operated to scan a biocular display without repositioning of the device. A pair of galvanometer sets are spaced apart from each other by a pupillary distance and coupled to a pair of autofocus lenses that each having optical fibers leading to one of a two slit array. A third galvanometer set selectively couples one of the pair of slits of the array to a spectrometer detector so that metrology of the biocular device can be sequentially switched between the two optical pathways to fully measure the optics of the biocular display. An anamorphic prism pair may be used to increase the efficiency of the transfer to the slits of the array.

### BACKGROUND OF THE INVENTION

### 1. Field

The present disclosure relates to metrology instruments and, more particularly, to a system for metrology of biocular devices.

### 2. Description of the Related Art

Conventional approaches for photometric measurements of near eye displays are limited by magnification, which reduces etendue if the focal length of the near-eye display increases. In some virtual display applications, such as windshield heads-up-display (HUD) and augmented reality heads-up-display (AR-HUD), devices used to project the images are biocular. Conventional approaches for testing these devices require positioning of a metrology instrumentin alignment with one of the optical elements to perform testing and then manually or robotically repositioning the metrology instrument in alignment with the other of the optical elements. This procedure is time consuming and can introduce errors into the evaluation process due to tight tolerances. Accordingly, there is a need in the art for a metrology instrument that can accurately and efficiently evaluate biocular devices.

### BRIEF SUMMARY OF THE INVENTION

The present invention provides a device that can be used for near eye display metrology that will work with longer focal lengths without employing bulky mechanisms. The device is positioned at the eye point of the display under test, where the virtual image field of view can be viewed uniformly (also known as the eyebox). When the device is actuated, a controller executes the scanning process to rapidly scan a focal point of the field of view at multiple virtual image distances (as seen through the near eye display optics), and the readings are collected and processed by the imager. Each reading corresponds to a field point in the field of view, which is collected sequentially to form an image. The measured image is used to calculate two-dimensional luminance, chromaticity, spectral radiance, spatial contrast, and resolution.

In an exemplary embodiment, the present device is a system for biocular near-eye display metrology comprising a focus lens with a defined field of view positioned along an optical path from an object to be imaged; one or more galvanometer sets located along that path to scan the field of view; a dispersive element positioned to receive the scanned light; and a detector positioned to receive the dispersed light. The galvanometer sets can include a pair of scanners spaced apart by a predetermined interpupillary distance and coupled via optical fibers to an array of entrance slits aligned with the focus lens path. For example, each scanner may be implemented as separate X and Y mirrors or as a single XY galvanometer capable of scanning both dimensions. Additionally, a pair of anamorphic prisms, each associated with one galvanometer set, compresses a scan width of about 6 mm to fit within a slit of about 2 mm, optionally with autofocus lenses interposed between each galvanometer and its associated prism. A computing system may be operatively coupled to drive the galvanometer sets, apply stored correction values for mirror angles, and process measurement data. Moreover, the galvanometers can receive light via pupil relay lenses, objective lenses, or relay lenses; be controlled to scan a predetermined slit height in the Y-dimension corresponding to the dispersive element's entrance slit; and permit adjustment of the interpupillary spacing by translating at least one scanner.

In another embodiment, the present disclosure includes a method for characterizing a biocular near-eye display comprising scanning a focal point of the focus lens with one or more galvanometer sets, directing the scanned focal point to a diffraction grating, and focusing the diffracted light onto a detector. The method may further include scanning light along a pair of optical paths corresponding to the display's virtual pupils, transmitting the scanned light via optical fibers to the slit array, sequentially selecting an entrance slit, dispersing light from the selected slit with the grating, and detecting the dispersed light to obtain both spectral and angular performance data. For example, each galvanometer set may be configured as an XY scanner to vary field angles in both X and Y dimensions and may pass the scan through anamorphic prisms that compress a 6 mm scan width to 2 mm before fiber delivery.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a diagram of a galvanometric system according to the present invention.

FIG. 2 is a diagram of a multichannel galvanometric system having two optical analysis pathways that converge to a single detector for metrology of a biocular device according to the present invention.

FIG. 3 is a schematic of a multichannel galvanometric system having two optical analysis pathways for metrology of a biocular device according to the present invention.

FIG. 4 is a schematic of X axis scanning using one channel of a multichannel galvanometric system according to the present invention.

FIG. 5 is a schematic of X axis scanning using one channel of a multichannel galvanometric system according to the present invention.

FIG. 6 is a diagram of a system for performing X axis scanning using one channel of a multichannel galvanometric system according to the present invention.

FIG. 7 is a schematic of Y axis scanning using one channel of a multichannel galvanometric system according to the present invention.

FIG. 8 is a schematic of Y axis scanning using one channel of a multichannel galvanometric system according to the present invention.

FIG. 9 is a schematic of a system for performing Y axis scanning using one channel of a multichannel galvanometric system according to the present invention

FIG. 10 is a diagram of a multichannel galvanometric system having two optical analysis pathways include anamorphic prisms for providing an input gain to the detector.

FIG. 11 is a schematic of anamorphic prisms for providing an input gain to the detector according to the present invention.

FIG. 12 is a schematic of an arrangement of lens pairs for conditioning the input from an ocular of a display to be measured without the use of an autofocus lens and XY galvanometer set according to the present invention.

### DETAILED DESCRIPTION OF THE INVENTION

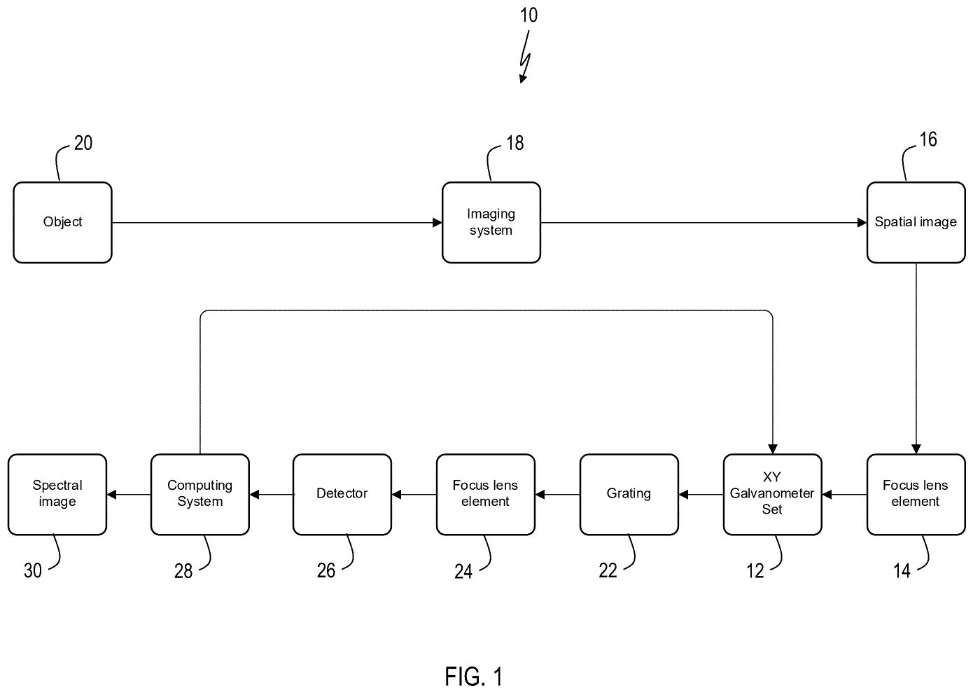

Referring to the figures, wherein like numerals refer to like parts throughout, there is seen in FIG. 1, a galvanometric system 10 having an XY galvanometer set 12 is positioned to adjacently to a relay lens 14 that received a spatial image 16 from an imaging system 18 associated with an object 20 to be evaluated. XY galvanometer set 12 configured to scan the field of view of relay lens 14 in the X and Y dimensions and is provided adjacently to the dispersive element 22 and focus lens 24 of a detector 26, such as a spectrograph, to provide an output the detector 26. XY galvanometer set 12 is controlled by a computer system 28 and driven to scan a predetermined slit height in the Y dimension corresponding to the entry slit of dispersive element 22 of detector 26. The spectral image 30 produced by detector 26 can be considered to determine quality of object 20. As described in more detail below, anamorphic prisms may be positioned between the output of XY galvanometer set 12 and the input to detector 26.

The mode of operation, which typically includes an XY galvanometer, scans a focal point from the input slit, or array of slits along direction X, in a direction Y that is along the slit height. XY galvanometer set 12 scans a focal point of relay lens 14 in directions that are perpendicular to illumination across the field of view. The XY field angles are deflected to an on-axis field angle that is focused through slit of detector 26. Anamorphic prisms coupled to linear fiber bundles may be situated at the input of the XY galvanometer set 12 and focus lens 24 to substantially enhance the fraction of rays transferred to detector 26. All angles may be scanned within the integration time of a single spot measurement or multiple measurements may be performed for spatial imaging. To reduce numerical aperture at the input, demagnification may be used with a relay lens pair with a longer focal length of the second lens than the first relay lens to increase the image area onto the slit of the spectrograph. As a result, the effective height of the image on the slit of the spectrograph of detector 26 can be larger than the absolute height of the slit of detector 26.

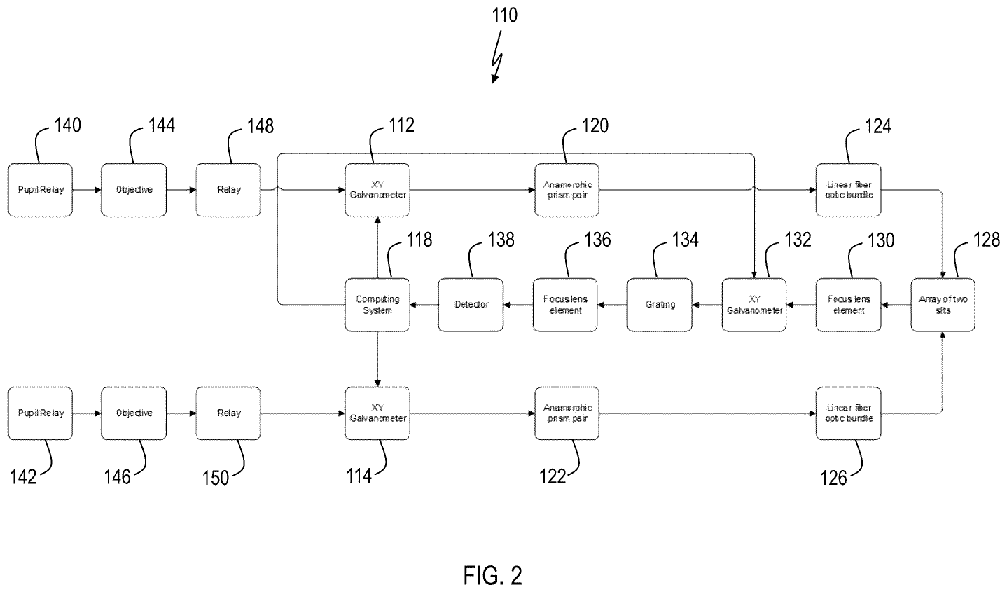

Referring to FIG. 2, a multichannel galvanometric system 110 comprising a pair of XY galvanometer sets 112, 114 that are spaced apart from each other and can be positioned to capture readings from a display, such as a heads-up-display (HUD), being tested. Each of the pair of XY galvanometer sets 112, 114 is coupled to a computing system 118 that is programmed to drive the operation of XY galvanometers 112, 114, i.e., control each mirror of the pair of XY galvanometer sets 112, 114. Computing system 118 preferably includes a processor with memory for storing correction values for the angles of the mirrors. The output of each of the pair of XY galvanometer sets 112, 114 are correspondingly coupled to each of a pair of anamorphic prism pairs 120, 122. The outputs of anamorphic prism pairs 120, 122 are correspondingly coupled to a pair of linear fiber optic bundles 124, 126 that optically connect the output of the pair of XY galvanometer sets 112, 114 to a single analysis pathway via an array 128 having a pair of slits. Each of the pair of slits serve as the sole input slit for one of the two input pathways leading from XY galvanometers 112, 114. A lens 130 is positioned in alignment with array 128 to focus incoming light into a third XY galvanometer set 132. XY galvanometer set 132 is coupled to computing system 118 and driven by computer system 118 to act a switch that can selectively provide light received from one or the other of the pair of XY galvanometer sets 112, 114 through grating 134 and a lens 136 to a detector 138, such as a spectrograph having a dispersive element to separate light into narrow bandwidths defined by the width of the pair of slits of the array 128. XY galvanometer set 132 may also be controlled to scan the slit height in the Y dimension, or scan multiple channel input slits in the X dimension. As further seen in FIG. 2, the input from the biocular components of the display may include a pair of pupil relays 140, 142, a pair of objective lenses 144, 146, and a pair of relay lenses 148, 150.

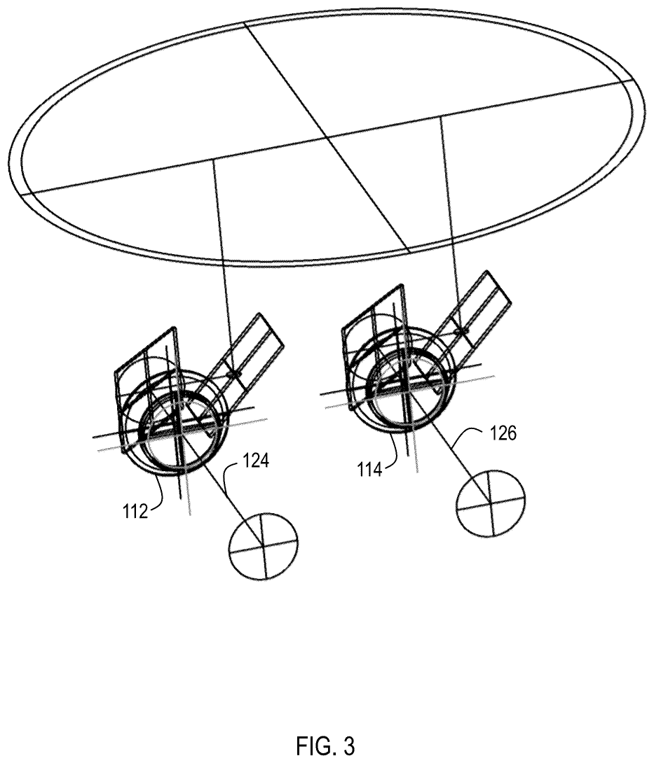

Referring to FIG. 3, XY galvanometer sets 112, 114 of system 110 may be spaced apart with a predetermined interpupillary distance to capture test reading from display 116. For example, XY galvanometer sets 112, 114 may be spaced apart by 62.5 millimeters, which is representative of an adult interpupillary distance. It should be recognized that XY galvanometer sets 112, 114 may be positioned on a rack or similar mechanical system for adjustment of the interpupillary distance, or secured in place to provide a fixed interpupillary distance. As illustrated in FIG. 2, the outputs of each of the pair of XY galvanometer sets 112, 114 are coupled via field stop optical fibers 124, 126 to detector 138. Additional field stop apertures may be added via an aperture wheel situated between the auto-focus lens and optical fibers.

Detector 138 may comprise a multichannel spectrograph along with XY galvanometer set 132 that can toggle between the inputs of optical fibers 124, 126 and thus selectively provide as an input to detector 138 a portion of one or the other of the outputs of XY galvanometer sets 112, 114. In one embodiment, the rightmost input from one of optical fibers 124, 126 may be spaced seven (7) millimeters horizontally from center, and the leftmost input from one of optical fibers 124, 126 may be spaced seven (7) millimeters horizontally from center, using the X mirror of XY galvanometer set 132, for spacing of +/−7 mm from center.

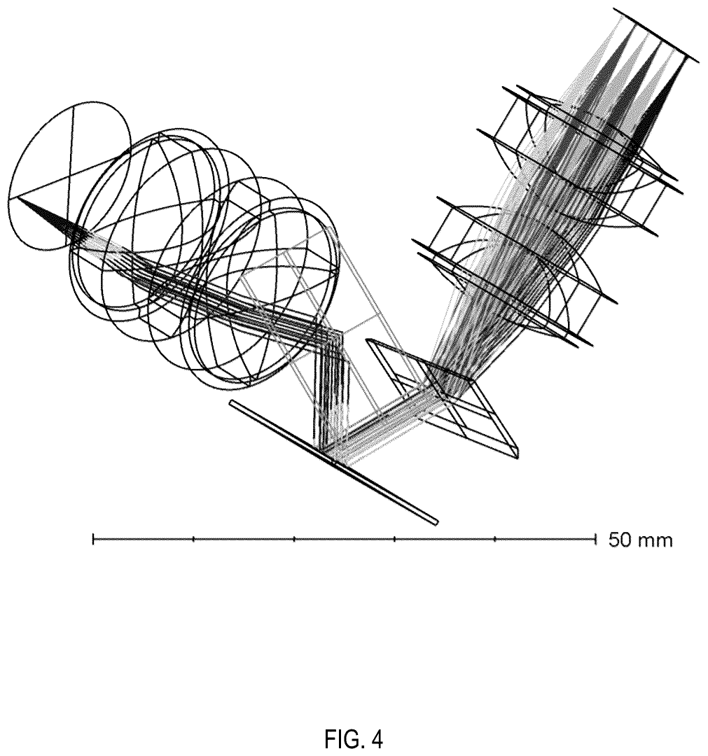

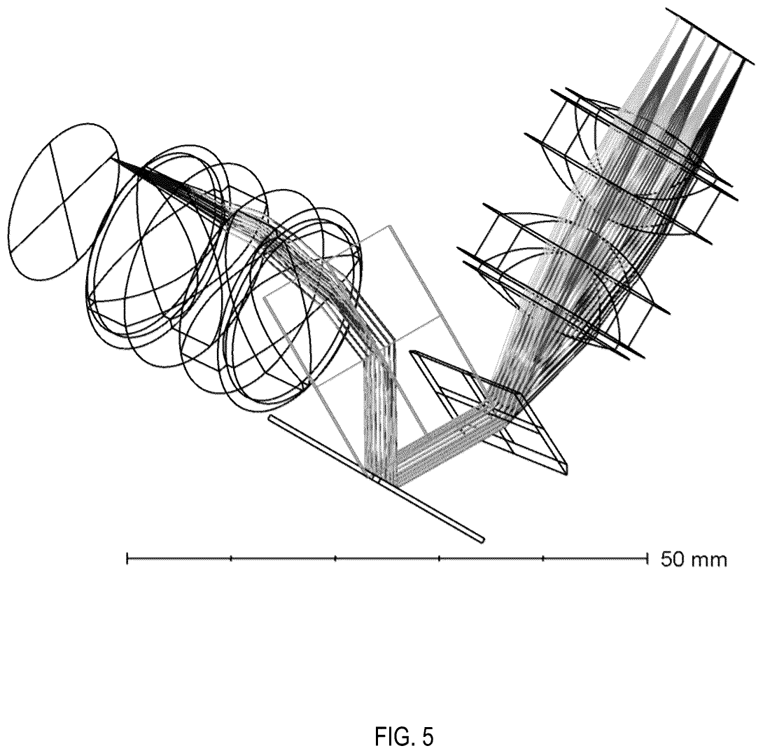

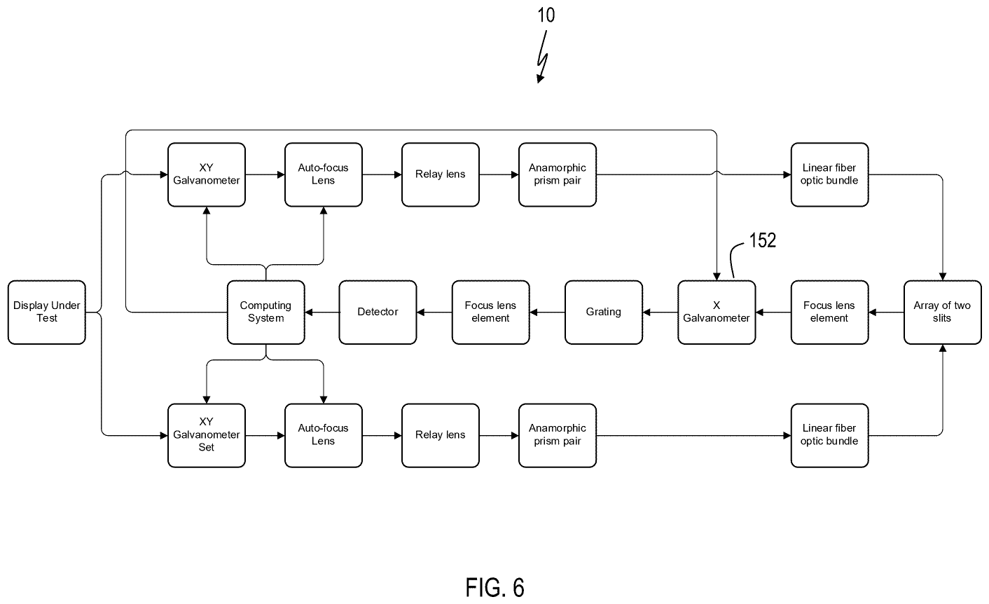

In a multichannel mode of operation, XY galvanometer set 132 scans a focal point from the channel input slits of array 128 in a direction X that is perpendicular to the slit height and perpendicular to the propagation of light. Multiplexed measurements in time are enabled when scanning multiple slit channel inputs with the X mirror of the XY galvanometer, or a dedicated X galvanometer, where the measurement capability effectively doubles for two slits. Fiber-coupled to the two slits is the output from a biocular device. All Y field angles are scanned within the integration time of the measurement of each slit scanned in X field angle. FIGS. 4 and 5 illustrate the mode of operation employing a dedicated X galvanometer 152 in lieu of XY galvanometer set 132, as seen in FIG. 6.

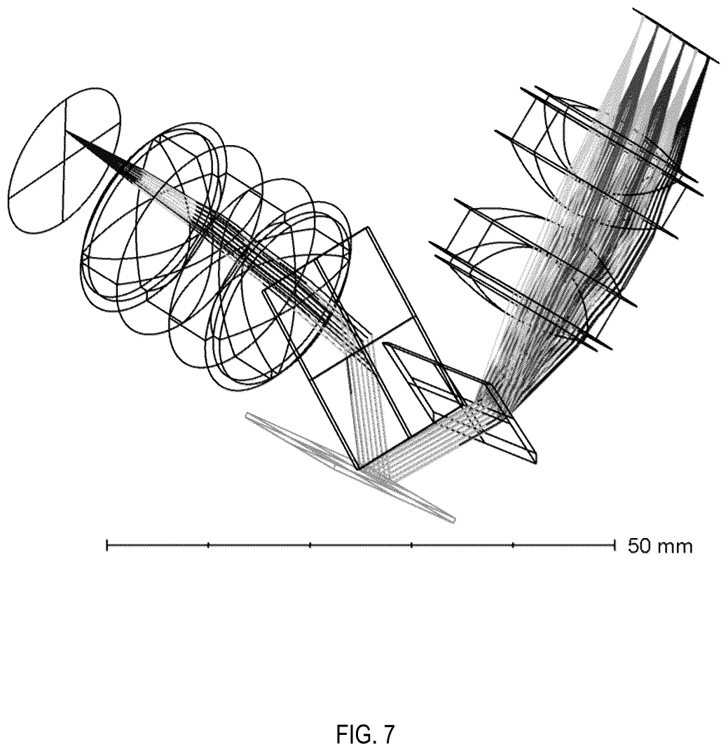

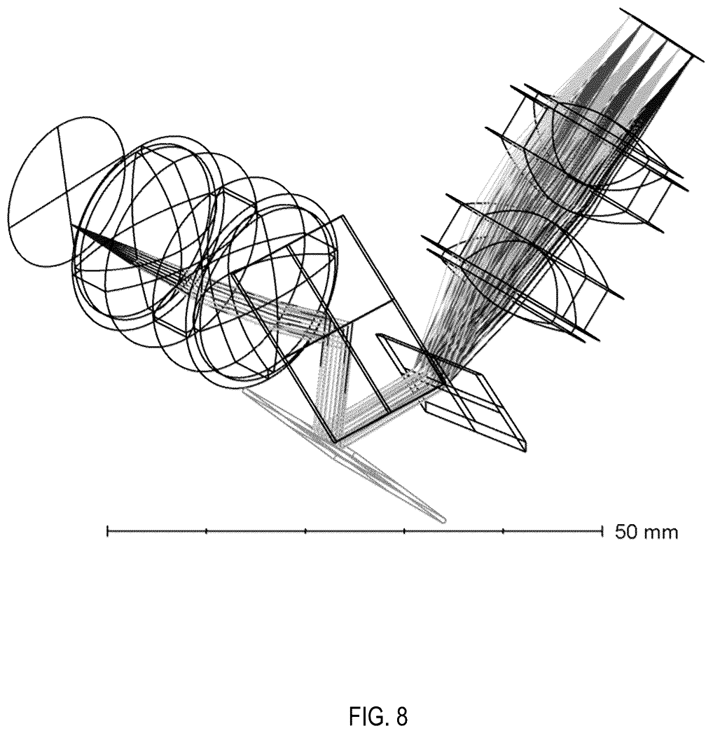

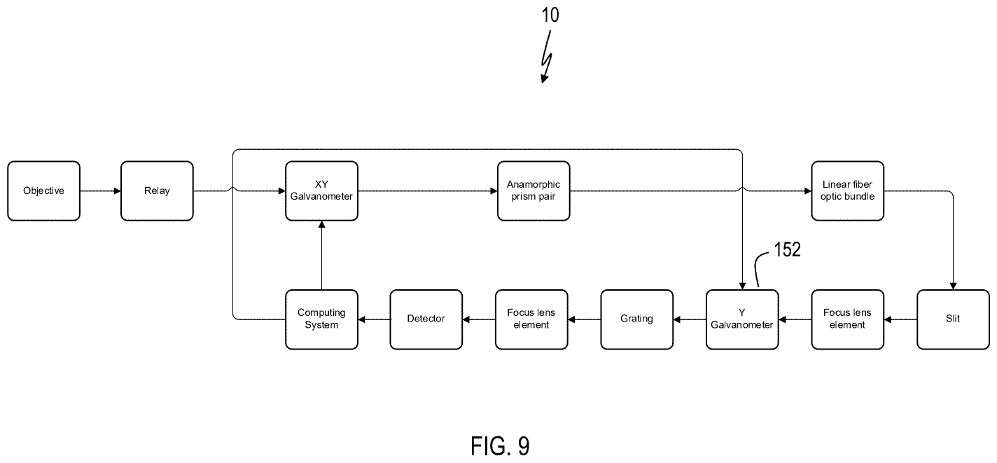

Referring to FIGS. 7 and 8, either one of XY galvanometer sets 112, 114 can also provide for laterally scanning of an input using the Y mirror of XY galvanometer set 132. In this embodiment, scanning via XY galvanometer set 32 can extend +/−3 mm with respect to center. XY galvanometer set 132 may also be driven to keep pupil stationary by including a third galvanometer. The first two mirrors are moved in the same plane so that the beam rotates about a pupil centered on the third mirror. FIG. 9 illustrates this mode of operation employing a dedicated Y galvanometer set 154 in lieu of an auto-focus lens and XY galvanometer set 132.

Thus, XY galvanometer sets 112, 114 of system 110 may be positioned at the eye point of the display under test, where the virtual image field of view can be viewed uniformly (also known as the eyebox). When XY galvanometer set 110 is actuated, computing system 118 executes the scanning process via one of the pair of XY galvanometer sets 112, 114 to rapidly scan a focal point of the field of view at multiple virtual image distances (as seen through the near eye display optics) from one of the bioptics of display 116 under test, and the readings are collected and processed by detector 138. Each reading corresponds to a field point in the field of view, which is collected sequentially to form an image. The measured image is used to calculate two-dimensional luminance, chromaticity, spectral radiance, spatial contrast, and resolution. Once completed, computing system 118 executes the scanning process via the other of the pair of XY galvanometer sets 112, 114 to rapidly scan a focal point of the field of view at multiple virtual image distances (as seen through the near eye display optics) from the other one of the bioptics of display 116 under test, and the readings are collected and processed by detector 138.

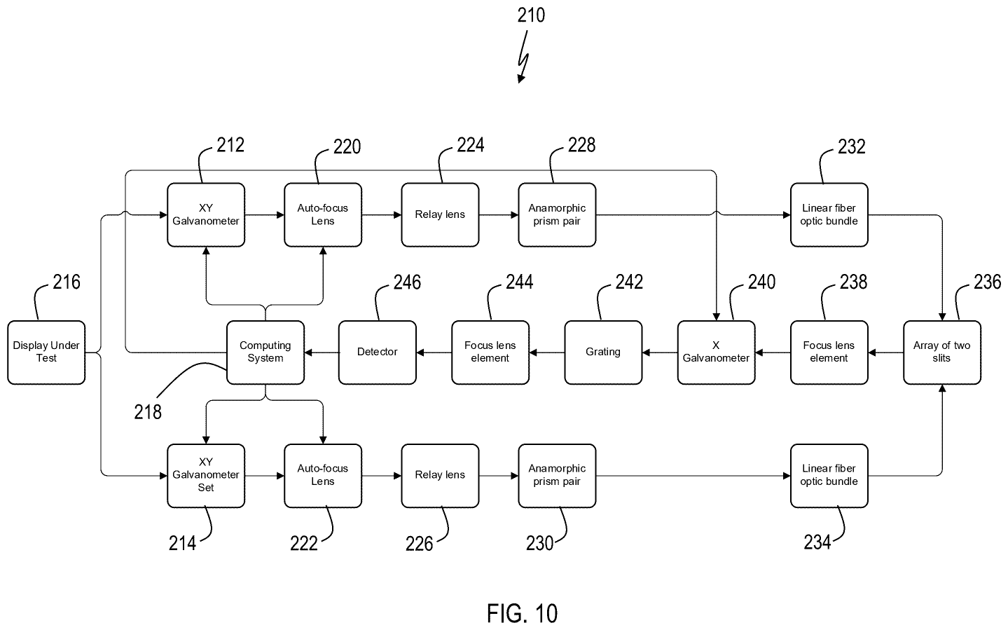

Referring to FIG. 10, a multichannel galvanometric system 210 may also comprise a pair of XY galvanometer sets 212, 214 that are spaced apart from each other and can be positioned to capture readings from a display 216, such as a heads-up-display (HUD), being tested. Each of the pair of XY galvanometer sets 212, 214 is coupled to a computing system 218 that is programmed to drive the operation of XY galvanometer sets 212, 214. The output of each of the pair of XY galvanometer sets 212, 214 are correspondingly coupled to a pair of auto-focus lens 220, 222. The outputs of relay lenses 224, 226 are each fed through a pair of prisms 228, 230 to a pair of linear fiber optical bundles 232, 234 to an array 236 having two slits, with each slit serving as the input slit for one of the two pathways. A lens 238 is positioned in alignment with array 236 to focus incoming light into an X galvanometer 240. X galvanometer 240 is coupled to and driven by computer system 218 to act a switch that can selectively provide light received from one or the other of the pair of XY galvanometer sets 212, 214 through a grating 242 and a lens 244 to a detector 246, such as a spectrometer.

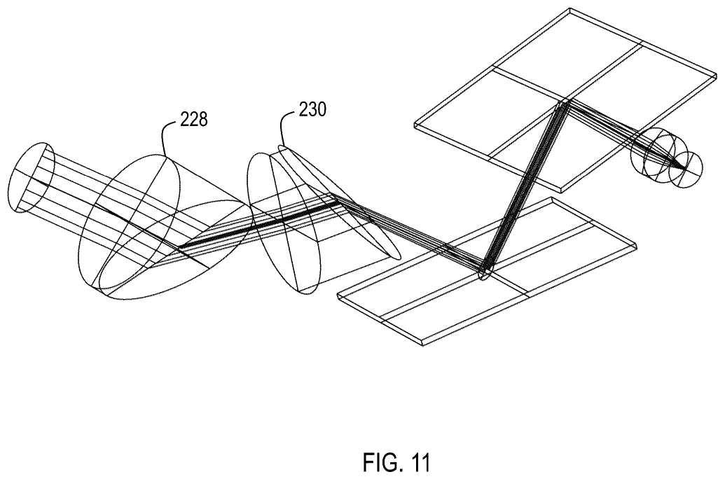

Referring to FIG. 11, each anamorphic prism pair 228, 230 can increase the efficiency of the transfer to the input slits of the array 236. More specifically, anamorphic prism pair 228, 230 increases the efficiency of the transfer from relay lenses 224, 226 to the input slit of the spectrograph used for detector 246. For example, conventional spectrographs normally use a two millimeter input slit. Anamorphic prism pair 228, 230 may be used so that a scan of a six millimeter axis by relay lenses 224, 226 is compressed to fit in the two millimeter slit of detector 246, thereby producing a gain for excessive numerical apertures not supported by conventional spectrographs.

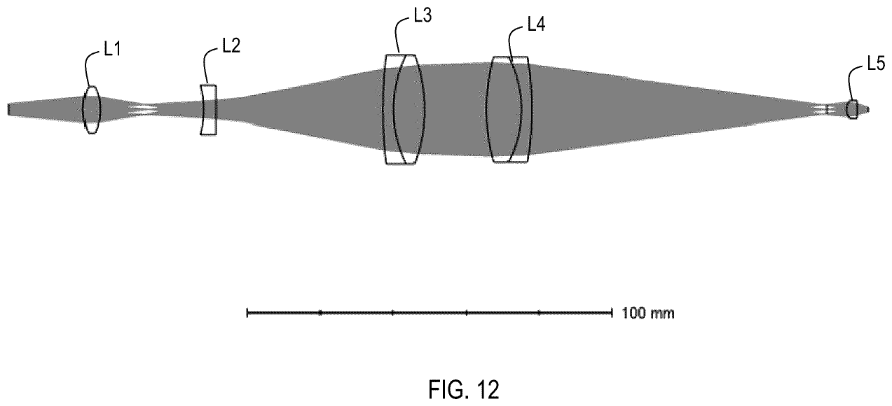

Referring to FIG. 12, lenses L1, L2, L3 (pupil relay), L4 (objective), and L5 (relay) may be used to condition the input image of a display under test in lieu of using an auto-focus lens and XY galvanometer set.

What is claimed is:

1. A device for near eye display metrology, comprising:
a focus lens having a field of view positioned along an optical path extending from object to be imaged;
at least one galvanometer set positioned along the optical path to perform a scan of the field of view of the focus lens;
a dispersive element positioned to receive the scan of the at least one galvanometer set; and
a detector positioned to receive the scan of the at least one galvanometer set after the dispersive element.

2. The device of claim 1, further comprising:
a pair of galvanometer sets spaced apart from each other according to a predetermined pupillary distance;
a pair of optical fibers coupled at one end to an array having a pair of slits; and
wherein the pair of slits are aligned with the optical path of the focus lens.

3. The device of claim 2, wherein the at least one galvanometer set comprises an X galvanometer.
The device of claim 2, wherein the at least one galvanometer set comprises a Y galvanometer.

5. The device of claim 2, further comprises a pair of anamorphic prisms, each of which is associated with one of the pair of galvanometer sets.

6. The device of claim 5, further comprising a pair of autofocus lenses, wherein each of the autofocus lenses is positioned between one of the pair of galvanometer sets and the associated one of the pair of anamorphic prisms.

7. The device of claim 2, wherein each of the pair of galvanometer sets comprises an XY galvanometer scanner configured to scan field angles in both X and Y dimensions.

8. The device of claim 1, further comprising a computing system operatively coupled to the at least one galvanometer set, the computing system being programmed to drive the at least one galvanometer set and to process any measurement data produced by the detector.

9. The device of claim 8, wherein the computing system includes correction values for governing mirror angles of the at least one galvanometer set and is programmed to apply the correction values.

10. The device of claim 2, wherein each of the pair of galvanometer sets is positioned to receive light from one of a pair of pupil relay lens, a pair of objective lens, and a pair of relay lens.

11. The device of claim 1, wherein the at least one galvanometer set is controlled to scan a predetermined height slit in the Y dimension corresponding to an entry slit of the dispersive element.

12. The device of claim 2, wherein each of the pair of slits of the array is associated with just one of the pair of galvanometer sets.

13. The device of claim 12, wherein the pair of galvanometer sets are spaced apart according to a predetermined interpupillary distance.

14. The device of claim 13, wherein the predetermined interpupillary distance is adjustable by translating at least one of the pair of galvanometer sets.

15. The device of claim 5, wherein each anamorphic prism pair compresses a scan having a width of about 6 millimeters so that the scan fits within a slit having a width of about 2 millimeters.

16. A method for characterizing a biocular near-eye display, comprising:
scanning with at least one galvanometer set a focal point of a focus lens;
providing the scanning of the focal point to a grating; and
focusing the scanning of the focal point that passes through the grating to a detector.

17. The method of claim 16, further comprising:
scanning light along a pair of optical paths with a pair of galvanometers positioned to correspond to a pair of virtual pupils of a display;
transmitting the scanned light of the pair of optical pathways via a corresponding pair of optical fibers to a corresponding pair of slits of an array;
sequentially selecting, with the at least one galvanometer set, one of the slits;
dispersing light from the slit to a diffraction grating; and
detecting the light dispersed from the slit with a detector to obtain spectral and angular performance data.

18. The method of claim 17, wherein each of the pair of galvanometer sets comprises an XY galvanometer configured to scan field angles in both X and Y dimensions.

19. The method of claim 18, further comprising passing the light scanned by the pair of galvanometers in each of the pair of optical paths through a corresponding one of a pair of anamorphic prisms before transmitting the scanned light via the pair of optical fibers.

20. The method of claim 19, wherein each anamorphic prism compresses the light scanned by the pair of galvanometers from a width of about 6 millimeters to a width of about 2 millimeters.
